(19) United States
(12) Patent Application Publication
(10) Pub. No.: US 2023/0001397 A1
(43) Pub. Date: Jan. 5, 2023

(54) COVALENT ORGANIC FRAMEWORKS AND APPLICATIONS THEREOF IN CHEMICAL REACTIONS

(71) Applicants: Shengqian MA, Tampa, FL (US); Qi SUN, Tampa, FL (US)

(72) Inventors: Shengqian MA, Tampa, FL (US); Qi SUN, Tampa, FL (US)

(21) Appl. No.: 17/776,768

(22) PCT Filed: Nov. 13, 2020
(86) PCT No.: PCT/US2020/060546

§ 371 Date: May 13, 2022

Related U.S. Application Data
(60) Provisional application No. 62/935,805, filed on Nov. 15, 2019.

(51) Int. Cl. B01J 31/16; B01J 35/02; B01J 37/02

(52) U.S. Cl. CPC B01J 31/1691; B01J 35/026; B01J 37/0221; B01J 2531/31; B01J 2531/37; B01J 2531/48

(57) ABSTRACT

organic frameworks that include catalytic components incorporated throughout the framework. These covalent organic frameworks have unique structural and physical properties, which lend these frameworks to be versatile and useful in a number of different applications and uses and chemical reactions. In one, the covalent organic frameworks include a plurality of fused aromatic groups or polyaromatic groups and ligands, where catalytic components such as transition metal catalysts are coordinated by the ligand to the frameworks.

### CROSS REFERENCE TO RELATED APPLICATIONS

This application claims priority upon U.S. provisional application Ser. No. 62/935,805 filed on Nov. 15, 2019. This application is hereby incorporated by reference in its entirety.

### BACKGROUND

Covalent organic frameworks (COFs) are molecular Legos® that enable the clear-cut integration of organic struts into extended crystalline frameworks²⁰⁻²⁸, tailor-made for use in a wide variety of applications such as catalysis²⁹⁻³², environmental remediation³³⁻³⁵, and bio-related applications³⁶⁻³⁸, to name a few³⁹⁻⁴¹. In the field of catalysis, COFs can provide a platform for the inclusion of a variety of different catalytic components. The unique structures of COFs can enhance the efficiency of the catalysts in a number of different chemical reactions.

### SUMMARY

Described herein are covalent organic frameworks that include catalytic components incorporated throughout the framework. The covalent organic frameworks have unique structural and physical properties, which lends them to be versatile in a number of different applications and uses. In one aspect, the covalent organic frameworks are composed of a plurality of fused aromatic groups or polyaromatic groups and ligands, where catalytic components such as transition metal catalysts are coordinated by the ligand to the framework. The covalent organic frameworks are useful in a number of different chemical reactions.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below:

FIGS. 1 and 2 show several organic frameworks described herein.

FIG. 3 shows two organic frameworks described herein with La coordinated to the framework.

FIG. 4 provides a schematic illustration of the preparation of a fabric coated with an organic framework described herein.

### DETAILED DESCRIPTION

Before the present materials, articles and/or methods are disclosed and described, it is to be understood that the aspects described below are not limited to specific compounds, synthetic methods, or uses, as such may, of course, vary. It is also to be understood that the terminology used herein is for the purpose of describing particular aspects only and is not intended to be limiting.

In the specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “a solvent” includes mixtures of two or more solvents and the like.

“Optional” or “optionally” means that the subsequently described event or circumstance can or cannot occur, and that the description includes instances where the event or circumstance occurs and instances where it does not. For example, the compositions described herein may optionally contain a pre-coating for a fiber, where the pre-coating may or may not be present.

Throughout this specification, unless the context dictates otherwise, the word “comprise,” or variations such as “comprises” or “comprising,” will be understood to imply the inclusion of a stated element, integer, step, or group of elements, integers, or steps, but not the exclusion of any other element, integer, step, or group of elements, integers, or steps.

As used herein, the term “about” is used to provide flexibility to a numerical range endpoint by providing that a given numerical value may be “a little above” or “a little below” the endpoint without affecting the desired result. For purposes of the present disclosure, “about” refers to a range extending from 10% below the numerical value to 10% above the numerical value. For example, if the numerical value is 10, “about 10” means between 9 and 11 inclusive of the endpoints 9 and 11.

As used herein, the term “admixing” is defined as mixing two or more components together so that there is no chemical reaction or physical interaction. The term “admixing” also includes the chemical reaction or physical interaction between the two or more components.

As used herein, “aryl group” is any carbon-based aromatic group including, but not limited to, benzene, naphthalene, etc. The term “aryl group” also includes “heteroaryl group,” which is defined as an aryl group that has at least one heteroatom incorporated within the ring of the aromatic ring. Examples of heteroatoms include, but are not limited to, nitrogen, oxygen, sulfur, and phosphorus. In one aspect, the heteroaryl group is imidazole. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

As used herein, “alkyl group” is a branched or unbranched saturated hydrocarbon group of 1 to 25 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. In one aspect, the alkyl group is a branched or unbranched C₁ to C₁₀ group.

As used herein, “aralkyl group” is an alkyl group as defined herein substituted with one or more aryl groups as defined herein. An example of an aralkyl group is a benzyl group.

As used herein, “alkoxy group” has the formula RO—, where R is an alkyl group, aryl group, or aralkyl group as defined herein.

As used herein, “hydroxyl group” has the formula —OH.

As used herein, “thioalkyl group” has the formula RS—, where R is an alkyl group, aryl group, or aralkyl group as defined herein.

As used herein, “thiol group” has the formula —SH.

As used herein, “amino group” has the formula —NH2.

The term “transition metal” as defined herein includes the elements of groups 3 to 11 in the periodic table as well as the lanthanide and actinide elements.

As used herein, a plurality of items, structural elements, compositional elements, and/or materials may be presented in a common list for convenience. However, these lists should be construed as though each member of the list is individually identified as a separate and unique member. Thus, no individual member of any such list should be construed as a de facto equivalent of any other member of the same list based solely on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an example, a numerical range of “about 1” to “about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, from about 1-about 3, from 1 to about 3, from about 1 to 3, etc., as well as 1, 2, 3, 4, and 5, individually. The same principle applies to ranges reciting only one numerical value as a minimum or maximum. The ranges should be interpreted as including endpoints (e.g., when a range of “from about 1 to 3” is recited, the range includes both of the endpoints 1 and 3 as well as the values in between). Furthermore, such an interpretation should apply regardless of the breadth or range of the characters being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference to each various individual combination and permutation of these compounds may not be explicitly disclosed, each is specifically contemplated and described herein. For example, if a fused aromatic group is disclosed and discussed, and a number of different ligands are discussed, each and every combination of fused aromatic group and ligand that is possible is specifically contemplated unless specifically indicated to the contrary. For example, if a class of fused aromatic groups A, B, and C are disclosed, as well as a class of ligands D, E, and F, and an example combination of A+D is disclosed, then even if each is not individually recited, each is individually and collectively contemplated. Thus, in this example, each of the combinations A+E, A+F, B+D, B+E, B+F, C+D, C+E, and C+F is specifically contemplated and should be considered from disclosure of A, B, and C; D, E, and F; and the example combination A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of the disclosure including, but not limited to, steps in methods of making and using the disclosed compositions. Thus, if there are a variety of additional steps that can be performed with any specific embodiment or combination of embodiments of the disclosed methods, each such composition is specifically contemplated and should be considered disclosed.

Covalent Organic Frameworks (COF)

Described herein are covalent organic frameworks. The covalent organic frameworks have unique structural and physical properties, which lends them to be versatile in a number of different applications and uses.

In one aspect, the covalent organic frameworks are assembled with a plurality of fused aromatic groups and electron-deficient chromophores as described herein. In one aspect, the organic framework comprises a plurality of structural units comprising the formula I

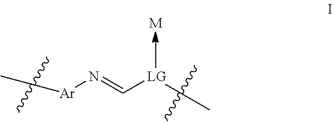

wherein Ar is a fused aromatic group or polyaromatic group;
LG is a ligand; and
M is a transition metal.

The squiggle line placed on the bonds in formula I represents a bond to another group (Ar or LG). For example, the structure of formula I is a monomeric unit (i.e., repeat unit) used to produce the organic frameworks described herein. Thus, the formulae described herein where squiggle lines are depicted represent units used to produce the organic framework.

The dimensions and physical properties of the organic framework can vary depending upon the number of structural units as depicted in formula I and the way in which the structural units are arranged in the framework. For example, the structural units of formula I can be positioned to produce the framework with the repeating structure

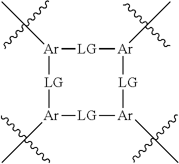

The structure above is represented as a square configuration; however, other configurations can be produced such as, for example three-sided, five-sided, six sided, seven-sided, or eight-sided structures.

The fused aromatic group Ar is a group that possesses two or more aromatic groups that share two carbon atoms. The fused aromatic group can consist entirely of carbon atoms or, in other aspect, can include one or more heteroatoms (e.g., oxygen nitrogen, sulfur, or any combination thereof). In one aspect, the fused aromatic group has from 2 to 10 fused aromatic groups, or 2, 3, 4, 5, 6, 7, 8, 9, or 10 aromatic groups, where any value can be a lower and upper end-point of a ranger (e.g., 2 to 8, 3 to 5, etc.).

In one aspect, the fused aromatic group comprises naphthalene, anthracene, acenaphthene, acenaphthylene, fluorene, phenalene, phenanthrene, benzo[a]anthracene, benzo[a]fluorine, benzo[c]phenanthrene, chrysene, fluoranthene, tetracene, anthanthrene, benzopyrene, pyrene, benzo[a]pyrene, benzo[e]pyrene, benzo[b]fluoranthene, benzo[j]fluoranthene, benzo[k]fluoranthene, corannulene, coronene, dicoronylene, diindenoperylene, helicene, heptacene, hexacene, kekulene, ovalene, pentacene, perylene, picene, or tetraphenylenepentacene. In another aspect, the fused aromatic group comprises a pyrene.

The organic framework comprises a plurality of fused aromatic groups. In one aspect, two or more different fused aromatic groups can be present in the organic framework. In another aspect, the fused aromatic group in the organic framework is the same fused aromatic group (e.g., pyrene).

The fused aromatic group can be substituted with one or more different groups. In one aspect, the fused aromatic group is substituted with one or more aryl groups. In another aspect, the fused aromatic group is substituted with 2 to 8 aryl groups, or 2, 3, 4, 5, 6, 7, or 8 aromatic groups, where any value can be a lower and upper end-point of a ranger (e.g., 2 to 6, 3 to 5, etc.). In one aspect, the aryl groups are symmetrically positioned around the fused aromatic group. In one aspect, the aryl group is the same group bonded to the fused aromatic group; however, two or more different aryl groups can be positioned on each fused aromatic group. In other aspects, the fused aromatic group can include a fused aromatic group substituted with one or more first aryl groups and a second fused aromatic group with one or more second aryl groups, where the first and second aryl groups are different.

In one aspect, the fused aromatic group comprises the structure of formula II

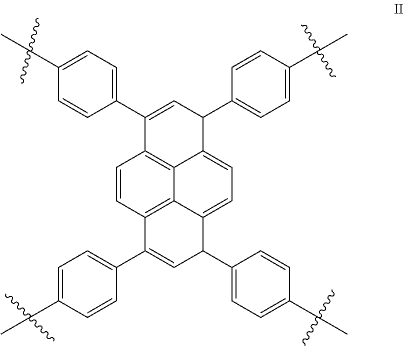 [SMILES: *c1ccc(C2=CC(c3ccc(*)cc3)c3ccc4c5c(ccc2c35)C(c2ccc(*)cc2)=CC4c2ccc(*)cc2)cc1]

Referring to formula II, the fused aromatic group is pyrene, where four phenyl groups (i.e., aryl groups) are symmetrically positioned about the pyrene structure. In one aspect, the organic framework includes only the structure of formula II with respect to the fused aromatic group.

The polyaromatic group as defined herein is a group that possess two or more aryl groups as defined here, wherein the aryl groups are not fused to one another. In one aspect, the polyaromatic group has from 2 to 10 aryl groups, or 2, 3, 4, 5, 6, 7, 8, 9, or 10 aryl groups, where any value can be a lower and upper end-point of a range. The aryl groups can be bonded directly to one another or connected to one another via a linker or other chemical group.

In one aspect, the polyaromatic group comprises the structure of formula V

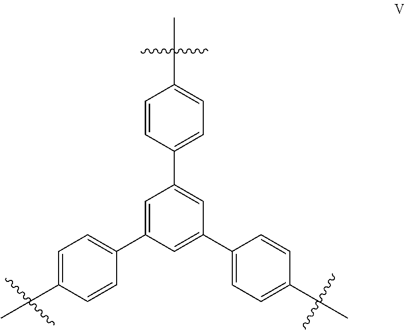 [SMILES: *c1ccc(-c2cc(-c3ccc(*)cc3)cc(-c3ccc(*)cc3)c2)cc1]

The organic frameworks described herein also include a ligand. The ligand is any group that bond or coordinate with the transition metal M. Depending upon the selection of the ligand and transition metal, the ligand can form a covalent, hydrogen, electrostatic, hydrogen, Van der Waals, or dative bond with the transition metal. In one aspect, the ligand can be a Lewis base. In another aspect, the ligand can be a Bronsted acid.

In one aspect, the ligand comprises and aryl group substituted with one or more hydroxyl groups, alkoxy groups, substituted or unsubstituted amino groups, thiol groups, thioalkyl groups, or any combination thereof. In another aspect, the ligand comprises an aryl group substituted with two hydroxyl groups. In another aspect, the ligand comprises the structure of formula III

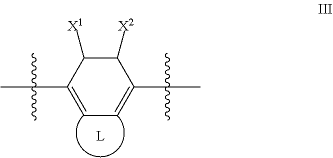

wherein L is not present or L is a fused aromatic group comprising 1 to 10 aromatic groups, and X¹ and X² are, independently, a hydroxyl group, an amino group, an alkoxy group, or a thiol group. In one aspect, X¹ and X² in formula III are hydroxyl groups.

In one aspect, the organic framework has a plurality of structural units having the formula IV

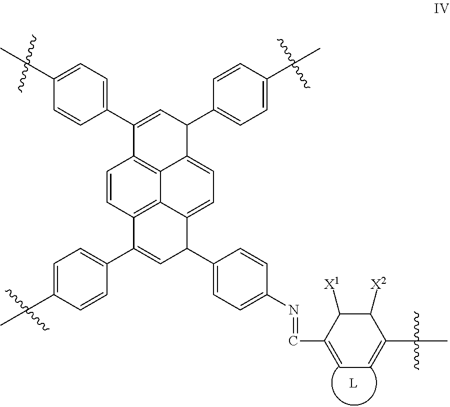

wherein L is not present or L is a fused aromatic group comprising 1 to 10 aromatic groups, and X¹ and X² are, independently, a hydroxyl group, an amino group, an alkoxy group, or a thiol group. In one aspect, X¹ and X² in formula IV are hydroxyl groups.

In one aspect, the organic framework has a plurality of structural units having the formula VI

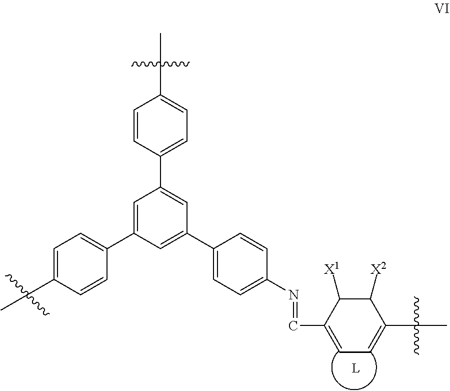

wherein L is not present or L is a fused aromatic group comprising 1 to 10 aromatic groups, and X¹ and X² are, independently, a hydroxyl group, an amino group, an alkoxy group, or a thiol group. In one aspect, X¹ and X² in formula VI are hydroxyl groups.

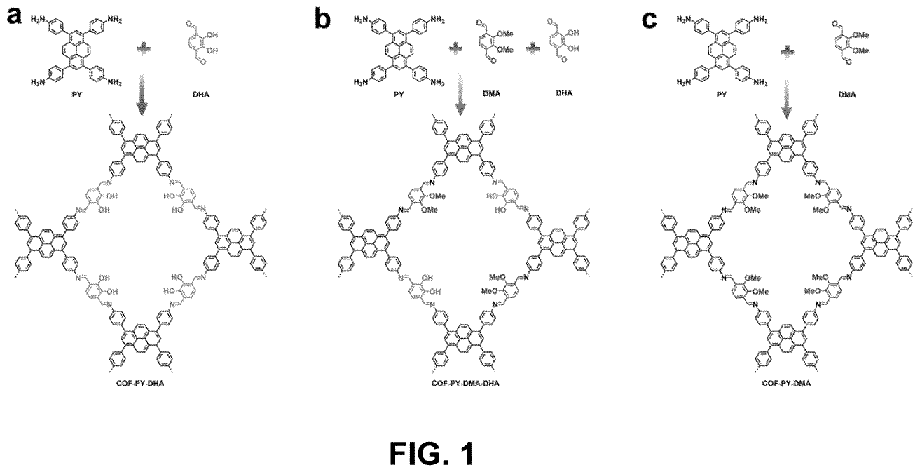

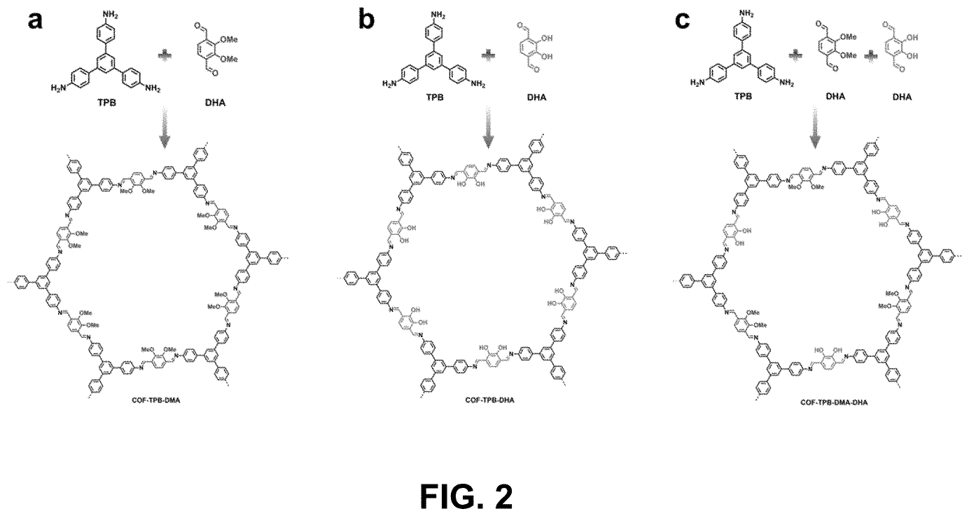

In another aspect, the organic framework comprises a plurality structural units having the structures depicted in FIG. 1 or 2.

The structural units present in the organic framework includes an imine group (—C═N—) that covalently bonds the fused aromatic group to the ligand. In one aspect, a Schiff's base reaction can be used to covalently bond the fused aromatic group to the ligand.

In one aspect, the organic framework is produced by reacting a fused aromatic group substituted with three or more amino groups with a ligand comprising two aldehyde groups. In one aspect, the fused aromatic group has four amino groups symmetrically positioned around the fused aromatic group. In one aspect, the fused aromatic group is 1,3,6,8-tetrakis(4-aminophenyl)pyrene. In another aspect, the polyaromatic group is 1,3,5-tris-(4-aminophenyl)benzene (TPB).

In one aspect, the ligand comprising two aldehyde groups comprises the formula VII

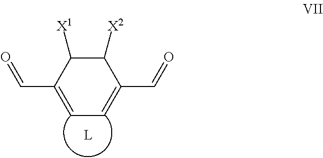

wherein L is not present or L is a fused aromatic group comprising 1 to 10 aromatic groups, and X¹ and X² are, independently, a hydroxyl group, an amino group, or a thiol group. In one aspect, X¹ and X² in formula VII are each a hydroxyl group.

After the organic framework has been synthesized, the transition metal is admixed with the framework in a solvent. The selection of the solvent can vary depending upon the selection of the transition metal and solubility of the framework. The transition metal can be a salt or organometallic compound. For example, the transition metal can be a metal halide, alkoxide, hydroxide, or carboxylate. Non-limiting procedures for producing organic frameworks described herein are provided in the Examples.

The organic frameworks are crystalline, porous, extended polymers with highly ordered and periodic two-dimensional (2D) or three-dimensional (3D) framework. In one aspect, the organic frameworks described herein comprise an unlimited stacking structure.

In one aspect, the channels have a pore size of about 2.0 nm to about 3.5 nm, or about 2.0 nm, about 2.25 nm, about 2.5 nm, about 2.75 nm, about 3.0 nm, about 3.25 nm, or about 3.5 nm, where any value can be a lower and upper endpoint of a range (e.g., about 2.25 nm to about 3.25 nm, etc.).

In one aspect, the organic frameworks described herein have a Connolly surface area of about 1,800 m²/g to about 2,800 m²/g, or about 1,800 m²/g, about 1,900 m²/g, about 2,000 m²/g, about 2,100 m²/g, about 2,200, m²/g, about 2,300 m²/g, about 2,400 m²/g, about 2,500 m²/g, about 2,600 m²/g, about 2,700 m²/g, or about 2,800 m²/g, where any value can be a lower and upper endpoint of a range (e.g., about 1,900 m²/g to about 2,600 m²/g, etc.).

In one aspect, the organic frameworks described herein have a Brunauer-Emmett-Teller (BET) surface area of about 500 m²/g to about 2,500 m²/g, or about 500 m²/g, about 600 m²/g, about 700 m²/g, about 800 m²/g, about 900 m²/g, about 1,000 m²/g, about 1,100 m²/g, about 1,200 m²/g, about 1,300 m²/g, about 1,400 m²/g, 1,500 m²/g, 1,600 m²/g, about 1,700 m²/g, about 1,800 m²/g, about 1,900 m²/g, about 2,000 m²/g, about 2,100 m²/g, about 2,200 m²/g, about 2,300 m²/g, about 2,400 m²/g, or about 2,500 m²/g, where any value can be a lower and upper endpoint of a range (e.g., about 700 m²/g to about 2,300 m²/g, about 900 m²/g to about 1,800 m²/g, etc.).

In one aspect, the organic frameworks described herein have a total pore volume of about 0.60 cm³/g to about 1.80 cm³/g, or about 0.60 cm³/g, about 0.7 cm³/g, about 0.80 cm³/g, about 0.9 cm³/g, about 1.0 cm³/g, about 1.1 cm³/g, about 1.2 cm³/g, about 1.3 cm³/g, about 1.4 cm³/g, about 1.5 cm³/g, about 1.6 cm³/g, about 1.7 cm³/g, or about 1.8 cm³/g, where any value can be a lower and upper endpoint of a range (e.g., about 0.7 cm³/g to about 1.6 cm³/g, about 0.8 cm³/g to about 1.2 cm³/g, etc.).

### Applications of Frameworks

Due to their unique structures and physical properties, the frameworks described herein can be used in numerous applications such as, for example, chemical reactions. In one aspect, the organic framework can be used as a hydrolysis catalyst. For example, one or more groups on an organic compound can be hydrolyzed to produce the corresponding hydroxyl group by reacting the organic compound with water in the presence of the organic framework. Non-limiting procedures for using the organic frameworks described herein as hydrolysis catalysts are provided in the Examples.

In one aspect, the organic frameworks described herein can be used to convert toxic chemicals to inert compounds. One such toxic chemical is nerve agents. As one of the most broadly used and notorious chemical weapons, sulfur mustard can cause grievous skin blisters and irritation to the respiratory system or even death at high doses.” In one aspect, the nerve agent is a halo-sulfo compound. In another aspect, the nerve agent is 2-chloroethyl ethyl sulfide or bis(2-chloroethyl) sulfide, diisopropyl phosphorofluoridate, dimethyl methylphosphonate, diethylsulfane, or 3,3-dimethylbutan-2-yl methylphosphonofluoridate. The transition metal can be selected based on the type of organic compound to be hydrolyzed. In one aspect, La (III) can be bonded to the organic framework for use as a hydrolysis catalyst. In another aspect, the transition metal can be a Lewis acid such as, for example, Al (III) and Zr (IV).

The organic frameworks described herein can be incorporated or used in batch or continuous processes. In one aspect, the organic framework can be inserted into a column, where water and the organic compound of interest are continuously passed through the column.

Due to the ability of the organic frameworks described herein to hydrolyze certain organic molecules such as nerve agents, the organic frameworks can be applied to fibers used to produce textiles, where the textiles can be worn by personnel that are exposed to these toxic compounds.

The fibers can be coated with the organic framework using techniques known in the art. In one aspect, the fibers are immersed in a solution of the organic framework then subsequently died. In certain aspect, the fiber can be pre-coated to enhance adhesion of the organic framework to the fiber. In one aspect, the fiber is coated with poly-dopamine followed by coating with the organic framework. Exemplary procedures for producing coated fibers are provided in the Examples. In one aspect, the fiber is a synthetic fiber such as, for example, a polyester, a polyamide (e.g., nylon), a polyalkylene oxide fiber, a glass fiber. In another aspect, the fiber is a natural fiber such as, for example, cotton, wool, or silk.

### Aspects

The following listing of exemplary aspects supports and is supported by the disclosure provided herein.

Aspect 1. An organic framework comprising a plurality of structural units comprising the formula I

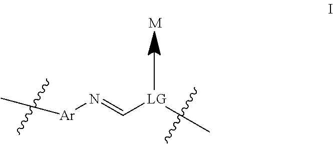

wherein Ar is a fused aromatic group or polyaromatic group;

LG is a ligand; and

M is a transition metal, a lanthanide, or an actinide.

Aspect 2. The organic framework according to aspect 1, wherein the fused aromatic group comprises 2 to 10 fused aromatic groups.

Aspect 3. The organic framework according to aspect 1, wherein the fused aromatic group comprises naphthalene, anthracene, acenaphthene, acenaphthylene, fluorene, phenalene, phenanthrene, benzo[a]anthracene, benzo[a]fluorine, benzo[c]phenanthrene, chrysene, fluoranthene, tetracene, anthanthrene, benzopyrene, pyrene, benzo[a]pyrene, benzo[e]pyrene, benzo[b]fluoranthene, benzo[j]fluoranthene, benzo[k]fluoranthene, corannulene, coronene, dicoronylene, diindenoperylene, helicene, heptacene, hexacene, kekulene, ovalene, pentacene, perylene, picene, or tetraphenylenepentacene.

Aspect 4. The organic framework according to aspect 1, wherein the fused aromatic group comprises a pyrene.

Aspect 5. The organic framework according to aspect 1, wherein the fused aromatic group is substituted with 2 to 8 aryl groups.

Aspect 6. The organic framework according to aspect 1, wherein the fused aromatic group comprises the structure of formula II

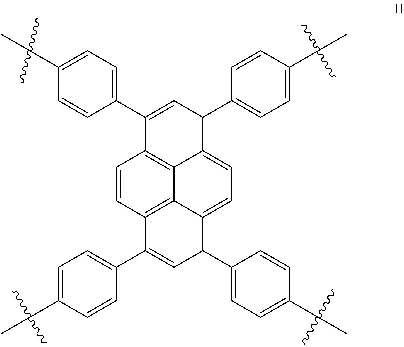 [SMILES: *c1ccc(C2=CC(c3ccc(*)cc3)c3ccc4c5c(ccc2c35)C(c2ccc(*)cc2)=CC4c2ccc(*)cc2)cc1]

Aspect 7. The organic framework according to aspect 1, wherein the ligand comprises and aryl group substituted with one or more hydroxyl groups, alkoxy groups, substituted or unsubstituted amino groups, thiol groups, thioalkyl groups, or any combination thereof.

Aspect 8. The organic framework according to aspect 1, wherein the ligand comprises an aryl group substituted with two hydroxyl groups.

Aspect 9. The organic framework according to aspect 1, wherein the ligand comprises the structure of formula III

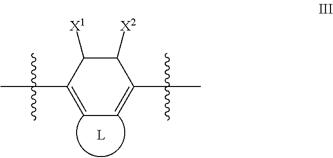

wherein L is not present or L is a fused aromatic group comprising 1 to 10 aromatic groups, and
X¹ and X² are, independently, a hydroxyl group, an amino group, an alkoxy group, or a thiol group.

Aspect 10. The organic framework according to aspect 9, wherein L is not present.

Aspect 11. The organic framework according to aspect 10, wherein X¹ and X² are hydroxyl groups.

Aspect 12. The organic framework according to aspect 1, wherein the structural unit has the formula IV

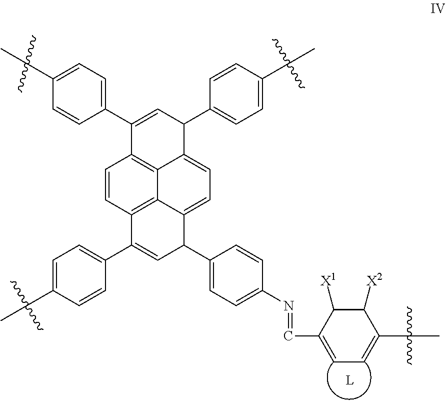

wherein L is not present or L is a fused aromatic group comprising 1 to 10 aromatic groups, and
X¹ and X² are, independently, a hydroxyl group, an amino group, an alkoxy group, or a thiol group.

Aspect 13. The organic framework according to aspect 12, wherein L is not present.

Aspect 14. The organic framework according to aspect 13, wherein X¹ and X² are hydroxyl groups.

Aspect 15. The organic framework according to aspect 1, wherein the polyaromatic group comprises the structure of formula V

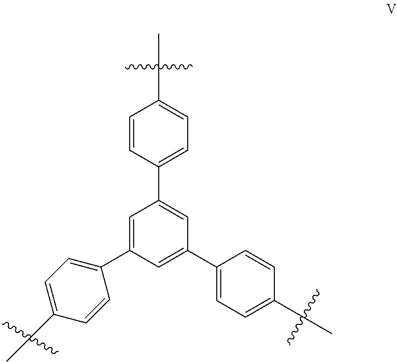 [SMILES: *c1ccc(-c2cc(-c3ccc(*)cc3)cc(-c3ccc(*)cc3)c2)cc1]

Aspect 16. The organic framework according to aspect 1, wherein the structural unit has the formula VI

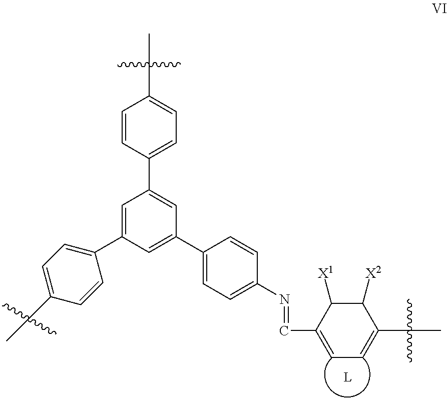

wherein L is not present or L is a fused aromatic group comprising 1 to 10 aromatic groups, and
X¹ and X² are, independently, a hydroxyl group, an amino group, an alkoxy group, or a thiol group.

Aspect 17. The organic framework according to aspect 16, wherein L is not present.

Aspect 18. The organic framework according to aspect 17, wherein X¹ and X² are hydroxyl groups.

Aspect 19. The organic framework according to aspect 1, wherein the framework comprises a plurality structural units having the structure depicted in FIG. 1 or 2.

Aspect 20. The organic framework according to any one of aspects 1-19, wherein M is a transition metal.

Aspect 21. The organic framework according to any one of aspects 1-20, wherein M is La (III), Al (III), or Zr (IV).

Aspect 22. An organic framework produced by (1) reacting a fused aromatic group or a polyaromatic group substituted with three or more amino groups with a ligand comprising two or more aldehyde groups to produce a first organic framework, and (2) reacting the first organic framework with a transition metal to produce the organic framework.

Aspect 23. The organic framework according to aspect 22, wherein the fused aromatic group is 1,3,6,8-tetrakis(4-aminophenyl)pyrene.

Aspect 24. The organic framework according to aspect 22, wherein the polyaromatic group is 1,3,5-tris-(4-aminophenyl)benzene (TPB).

Aspect 25. The organic framework according to any one of aspects 22 to 24, wherein the ligand comprises the formula VII

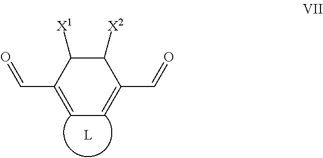

wherein L is not present or L is a fused aromatic group comprising 1 to 10 aromatic groups, and X¹ and X² are, independently, a hydroxyl group, an amino group, or a thiol group.

Aspect 26. The organic framework according to any one of aspects 1-25, wherein the framework comprises an unlimited stacking structure.

Aspect 27. The organic framework according to any one of aspects 1-26, wherein the framework comprises a plurality of channels, wherein the pore size of the channels is from about 2.0 nm to about 3.5 nm.

Aspect 28. The organic framework according to any one of aspects 1-27, wherein the framework has a Connolly surface area of about 1,800 m²/g to about 2,800 m²/g.

Aspect 29. The organic framework according to any one of aspects 1-28, wherein the framework has a Brunauer-Emmett-Teller (BET) surface area of about 500 m²/g to about 2,500 m²/g.

Aspect 30. The organic framework according to any one of aspects 1-29, wherein the framework has a total pore volume of about 0.6 cm³/g to about 1.8 cm³/g.

Aspect 31. The use of the organic framework according to any one of aspects 1-30 as a hydrolysis catalyst.

Aspect 32. A method for hydrolyzing an organic compound, comprising reacting the organic compound with water in the presence of the organic framework according to any one of aspects 1-30.

Aspect 33. The method according to aspect 32, wherein the organic compound is a nerve agent.

Aspect 34. The method according to aspect 33, wherein the organic compound is a halo-sulfo compound.

Aspect 35. The method according to aspect 32, wherein the organic compound is 2-chloroethyl ethyl sulfide or bis(2-chloroethyl) sulfide, diisopropyl phosphorofluoridate, dimethyl methylphosphonate, diethylsulfane, or 3,3-dimethylbutan-2-yl methylphosphonofluoridate.

Aspect 36. The method according to any one of aspects 32-34, wherein the method is conducted in a batch process or continuous process.

Aspect 37. A fiber comprising a coating of the organic framework according to any one of aspects 1-30.

Aspect 38. The fiber according to aspect 37, wherein the fiber comprises a synthetic fiber.

Aspect 39. The fiber according to aspect 38, wherein the synthetic fiber comprises a polyester, a polyamide, a polyalkylene oxide fiber, a glass fiber.

Aspect 40. The fiber according to aspect 39, wherein the fiber comprises a natural fiber.

Aspect 41. The fiber according to aspect 40, wherein the natural fiber comprises cotton, wool, or silk.

### Examples

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. Numerous variations and combinations of reaction conditions (e.g., component concentrations, desired solvents, solvent mixtures, temperatures, pressures, and other reaction ranges and conditions) can be used to optimize the product purity and yield obtained from the described process. Only reasonable and routine experimentation will be required to optimize such process conditions.

### Monomers Synthesis

### Synthesis of 1,3,6,8-tetrakis(4-aminophenyl)pyrene (PY)

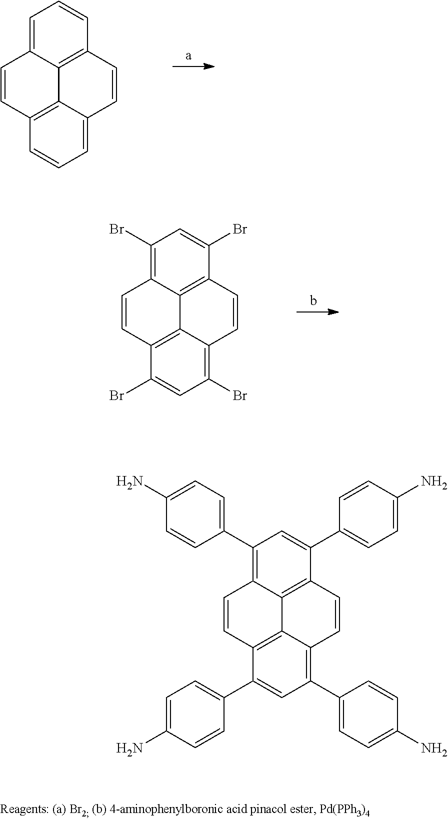

1,3,6,8-tetrabromopyrene. To a mixture of pyrene (10.1 g, 50.0 mmol) and nitrobenzene (350 mL), Br₂ (220 mmol in 200 mL of nitrobenzene) was added dropwise. After the addition was complete, the yellow suspension was heated at 120° C. for 18 h and then cooled to room temperature. The precipitate was filtered off, washed with ethanol, and dried under vacuum to yield 1,3,6,8-tetrabromopyrene as a pale yellow solid (24.2 g, 94%). The product was found to be insoluble in all common organic solvents, limiting characterization.

1,3,6,8-tetrakis(4-aminophenyl)pyrene. 1,3,6,8-Tetrabromopyrene (1.48 g, 2.86 mmol), 4-aminophenylboronic acid pinacol ester (3.0 g, 13.7 mmol), K₂CO₃ (2.2 g, 15.8 mmol), and Pd(PPh₃)₄ (0.33 g, 0.29 mmol) were introduced into a mixture of 1,4-dioxane (50 mL) and H₂O (10 mL). The resulting mixture was refluxed at 115° C. under N₂ atmosphere for 3 d. After cooling to room temperature, the solution was poured into water and the resulting precipitate was filtered off, washed with water and methanol. The resulting solid was further purified by flash chromatography with acetone as eluent to afford the title compound as a yellow-brown solid. Yield: (1.49 g, 92%). ¹H NMR (400 MHz, d6-DMSO, 298K, TMS): δ 8.13 (s, 4H), 7.79 (s, 2H), 7.35 (d, 8H, J=8.4 Hz), 6.77 (d, 8H, J=8 Hz), 5.32 (s, 8H) ppm. ¹³C NMR (125 MHz, d6-DMSO, 298K, TMS) 148.69, 137.59, 131.52, 129.50, 128.03, 127.17, 126.58, 124.89, 114.4 ppm.

### Synthesis of 1,3,5-tris-(4-aminophenyl)benzene (TPB)

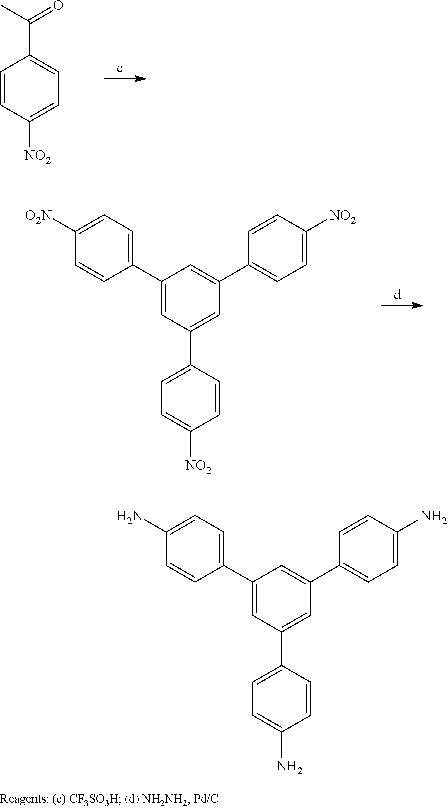 [SMILES: CC(=O)c1ccc([N+](=O)[O-])cc1 ; O=[N+]([O-])c1ccc(-c2cc(-c3ccc([N+](=O)[O-])cc3)cc(-c3ccc([N+](=O)[O-])cc3)c2)cc1 ; Nc1ccc(-c2cc(-c3ccc(N)cc3)cc(-c3ccc(N)cc3)c2)cc1]

1,3,5-tris(4-nitrophenyl)benzene. 4-Nitroacetophenone (50 g), toluene (200 mL), and CF₃SO₃H (2.0 mL) were added to a flask equipped with a water separator and a cooling condenser. The mixture was refluxed for 48 h, during this time the formed water was eliminated as a toluene azeotrope. After being cooled to room temperature, the mixture was filtered and washed with DMF under refluxing to yield a grey-green solid product after drying. This product is insoluble in any common solvent.

1,3,5-tris-(4-aminophenyl)benzene. A suspension of 1,3,5-tris(4-nitrophenyl)benzene (12.5 g, 28.4 mmol) and Pd/C (5 wt %, 2.0 g) in ethanol (200 mL) was heated to reflux. Hydrazine hydrate (30 mL) was added in portions, and the resulting mixture was refluxed overnight. After that, the mixture was hot filtered through celite and the filtrate was left undisturbed to fully crystallize the product. The solid was collected by filtration and washed with cold ethanol. Yield: 8.3 g (84%). ¹H NMR (400 MHz, d6-DMSO, 298K, TMS): δ 7.50 (t, 9H, J=5.8 Hz), 6.69 (d, 6H, J=8.4 Hz), 5.22 (s, 6H) ppm. ¹³C NMR (125 MHz, d6-DMSO, 298K, TMS) 193.65, 138.46, 135.77, 132.45, 130.59, 120.48 ppm.

### Synthesis of 2,3-dimethoxyterephthalaldehyde (DMA) and 2,3-dihydroxyterephthalaldehyde (DHA)

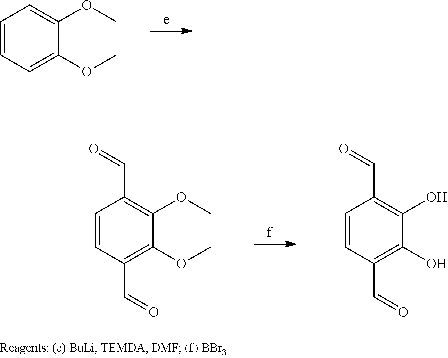

2,3-dimethoxyterephthalaldehyde. To a solution of o-dimethoxybenzene (1.26 mL, 10 mmol) and N,N,N′,N′-tetramethylethylenediamine (TEMDA, 50 mmol) in diethyl ether (Et₂O, 80 mL), n-butyllithium (2.6 M in hexane, 19 mL, 50 mmol) was added at 0° C. under N₂ atmosphere. The reaction mixture was allowed to warm to room temperature, and then stirred for 24 h. To the reaction mixture, was added DMF (4.2 mL, 55 mmol) dropwise at 0° C. The reaction mixture was stirred overnight at room temperature. After being quenched by 1 M HCl aqueous solution, the resulting mixture was extracted with Et₂O. The organic layer was dried over Na₂SO₄, filtered, and concentrated under reduced pressure. The residue was purified by flash column chromatography with hexane/EtOAc=10/1 as eluent to afford 2,3-dimethoxyterephthalaldehyde as a light yellow solid. Yield: 0.64 g (33%). ¹H NMR (400 MHz, d6-DMSO, 298K, TMS): δ 10.35 (s, 2H), 7.57 (s, 2H), 4.02 (s, 6H) ppm. ¹³C NMR (125 MHz, d6-DMSO, 298K, TMS) 190.18, 156.78, 134.34, 122.76, 63.02 ppm.

2,3-dihydroxyterephthalaldehyde. To a solution of 2,3-dimethoxyterephthalaldehyde (1.0 g) in dry dichloromethane (DCM, 150 mL), BBr₃ (2.0 mL) in 50 mL of CH₂Cl₂ was added dropwise at 0° C. under N₂ atmosphere. After being stirred overnight at room temperature, the mixture was cooled to 0° C. and water (20 mL) was added in drops to quench the reaction. The residue was extracted with CH₂Cl₂, washed with brine, dried over MgSO₄, and evaporated under reduced pressure, giving the crude compound which was purified by flash chromatography with hexane/ethyl acetate (5:1) as eluent to afford the title compound as an orange solid. Yield: 0.83 g (96%). ¹H NMR (400 MHz, d6-DMSO, 298K, TMS) δ10.75 (br, 2H), 10.29 (s, 2H), 7.26 (s, 2H). ¹³C NMR (100 MHz, d6-DMSO, 298K, TMS) 193.05, 151.23, 126.17, 119.23 ppm.

COFs Synthesis

COF-PY-DMA (FIG. 1). A Schlenk tube (10 mL) was charged with 2,3-dimethoxyterephthalaldehyde (DMA, 33.8 mg, 0.2 mmol) and 1,3,6,8-tetrakis(4-aminophenyl)pyrene (PY, 55.6 mg, 0.1 mmol) in 5.5 mL of a 5:5:1 v/v/v solution of 1,2-dichlorobenzene/n-butylalcohol/6 M aqueous acetic acid. The tube was flash frozen at 77 K (liquid N₂ bath), evacuated, and sealed. The reaction mixture was heated at 120° C. for 3 days to afford a yellow precipitate which was isolated by filtration and washed with anhydrous tetrahydrofuran (THF) using Soxhlet extraction for 2 d. The product was dried under vacuum to afford COF-PY-DMA

COF-PY-DHA (FIG. 1). A Schlenk tube (10 mL) was charged with 2,3-dihydroxyterephthalaldehyde (DHA, 33.2 mg, 0.2 mmol) and 1,3,6,8-tetrakis(4-aminophenyl)pyrene (PY, 55.6 mg, 0.1 mmol) in 5.5 mL of a 5:5:1 v/v/v solution of 1,2-dichlorobenzene/n-butylalcohol/6 M aqueous acetic acid. The tube was flash frozen at 77 K (liquid N₂ bath), evacuated, and sealed. The reaction mixture was heated at 120° C. for 3 days to afford a brick red precipitate which was isolated by filtration and washed with anhydrous THF using Soxhlet extraction for 2 d. The product was dried under vacuum to afford COF-PY-DHA.

COF-PY-DMA-xDHA (FIG. 1) (x stands for the mole ratio of 2,3-dihydroxyterephthalaldehyde and 2,3-dimethoxyterephthalaldehyde used). As a typical procedure, to the mixture of 2,3-dimethoxyterephthalaldehyde (19.4 mg, 0.1 mmol), 2,3-dihydroxyterephthalaldehyde (16.6 mg, 0.1 mmol) and 1,3,6,8-tetrakis(4-aminophenyl)pyrene (PY, 55.6 mg, 0.1 mmol) in a Schlenk tube (10 mL), 5.5 mL of a 5:5:1 v/v/v solution of 1,2-dichlorobenzene/n-butylalcohol/6 M aqueous acetic acid was introduced. After a brief sonication, the tube was flash frozen at 77 K (liquid N₂ bath), evacuated, and sealed. The reaction mixture was heated at 120° C. for 3 days to afford an orange precipitate which was isolated by filtration and washed with anhydrous tetrahydrofuran using Soxhlet extraction for 2 days, yielding the product denoted as COF-PY-DMA-DHA. Other COF materials with different ratios of DMA and DHA were synthesized according to the same procedure except for that different mole ratios of 2,3-dimethoxyterephthalaldehyde and 2,3-dimethoxyterephthalaldehyde were introduced.

COF-TPB-DMA (FIG. 2). A Schlenk tube (10 mL) was charged with 2,3-dimethoxyterephthalaldehyde (DMA, 116.0 mg, 0.6 mmol) and 1,3,5-tris(4-aminophenyl)benzene (TPB, 140.0 mg, 0.4 mmol) in 5.5 mL of a 5:5:1 v/v/v solution of 1,2-dichlorobenzene/n-butylalcohol/6 M aqueous acetic acid. The tube was flash frozen at 77 K (liquid N₂ bath), evacuated, and sealed. The reaction mixture was heated at 120° C. for 3 days to afford a yellow precipitate which was isolated by filtration and washed with anhydrous tetrahydrofuran (THF) using Soxhlet extraction for 2 d. The product was dried under vacuum to afford COF-TPB-DMA

COF-TPB-DHA (FIG. 2). A Schlenk tube (10 mL) was charged with 2,3-dihydroxyterephthalaldehyde (DHA, 99.5 mg, 0.6 mmol) and 1,3,5-tris(4-aminophenyl)benzene (TPB, 140.0 mg, 0.4 mmol) in 5.5 mL of a 5:5:1 v/v/v solution of 1,2-dichlorobenzene/n-butylalcohol/6 M aqueous acetic acid. The tube was flash frozen at 77 K (liquid N₂ bath), evacuated, and sealed. The reaction mixture was heated at 120° C. for 3 days to afford a brick red precipitate which was isolated by filtration and washed with anhydrous THF using Soxhlet extraction for 2 d. The product was dried under vacuum to afford COF-TPB-DHA.

COF-TPB-DMA-xDHA (FIG. 2) (x stands for the mole ratio of 2,3-dihydroxyterephthalaldehyde and 2,3-dimethoxyterephthalaldehyde used). As a typical procedure, to the mixture of 2,3-dimethoxyterephthalaldehyde (58.0 mg, 0.3 mmol), 2,3-dihydroxyterephthalaldehyde (50.0 mg, 0.3 mmol) and 1,3,5-tris(4-aminophenyl)benzene (140.0 mg, 0.4 mmol) in a Schlenk tube (10 mL), 5.5 mL of a 5:5:1 v/v/v solution of 1,2-dichlorobenzene/n-butylalcohol/6 M aqueous acetic acid was introduced. After a brief sonication, the tube was flash frozen at 77 K (liquid N₂ bath), evacuated, and sealed. The reaction mixture was heated at 120° C. for 3 days to afford an orange precipitate which was isolated by filtration and washed with anhydrous tetrahydrofuran using Soxhlet extraction for 2 days, yielding the product denoted as COF-TPB-DMA-DHA. Other COF materials with different ratios of DMA and DHA were synthesized according to the same procedure except for that different mole ratios of 2,3-dimethoxyterephthalaldehyde and 2,3-dimethoxyterephthalaldehyde were introduced.

COFs-La Synthesis

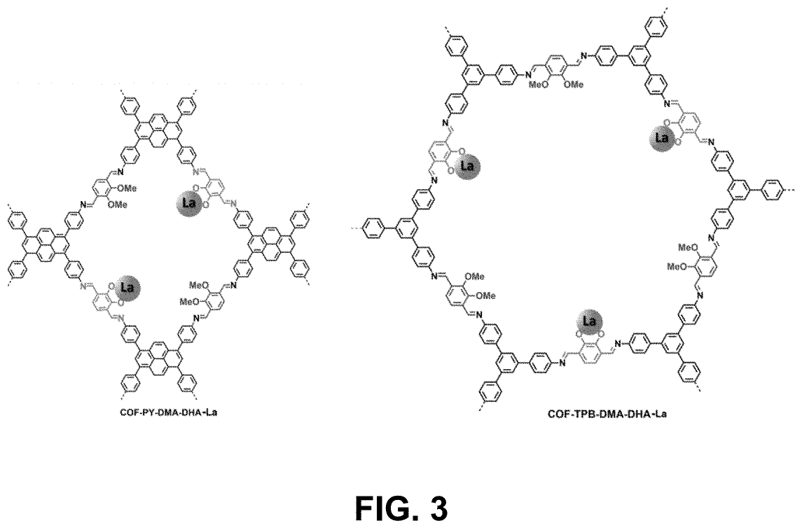

COF-PY-DMA-xDHA-La (FIG. 3). COF-PY-DMA-xDHA (100 mg) was added to a solution of La (acac)₃. H₂O (260 mg, 0.57 mmol) in MeOH (10 mL) and stirred at 50° C. for 18 h. The suspension was filtered and the solid polymer was washed with MeOH using Soxhlet extraction for 12 h. The remaining material was activated under vacuum at 100° C. for 12 h.

COF-TPB-DMA-xDHA-La (FIG. 3). COF-TPB-DMA-xDHA (100 mg) was added to a solution of La (acac)₃. H₂O (260 mg, 0.57 mmol) in MeOH (10 mL) and stirred at 50° C. for 18 h. The suspension was filtered and the solid polymer was washed with MeOH using Soxhlet extraction for 12 h. The remaining material was activated under vacuum at 100° C. for 12 h.

### COF-TPB-DMA-xDHA-La@Nylon-66 Synthesis

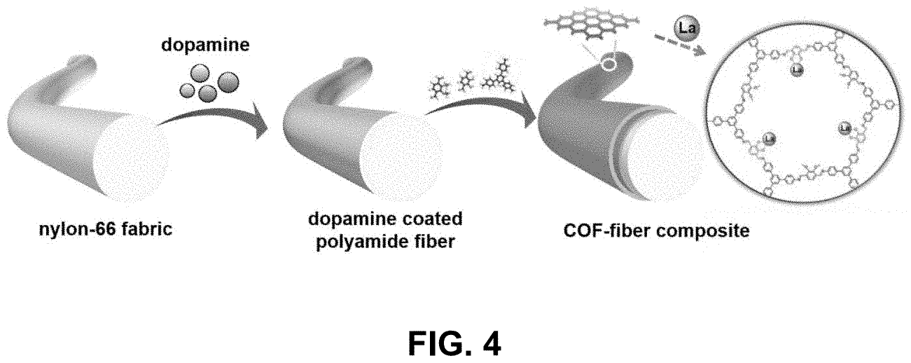

Synthesis of COF-TPB-DMA-xDHA-La coated nylon-66 fabric (COF-TPB-DMA-xDHA-La@nylon-66) (FIG. 4). To achieve the title composite materials, the melamine foam and nylon-66 fabric were coated with a layer of poly-dopamine, by soaking in a dopamine Tris-HCl solution (pH=8.5) for 24 h. After that, the substrates were filtered, rinsed with deionized water and acetone, and dried under vacuum to yield the poly-dopamine coated materials. The COF-PY-DMA-xDHA coated nylon-66 fabric was achieved by immersion the corresponding poly-dopamine coated materials into the COF-PY-DMA-xDHA synthetic system as described above. The La species metalated composites were achieved by the similar procedure as that of COF-TPB-DMA-xDHA-La, except that 50 mg of La (acac)₃. H₂O was used. Table 1 provides the amount of La incorporated into each organic framework and coated nylon.

TABLE 1
The La loading amount in various catalyst.

| Catalyst | La content (mmol g⁻¹) |
|---|---|
| COF-TPB-DHA-La | 2.42 |
| COF-TPB-DMA-2DHA-La | 1.65 |
| COF-TPB-DMA-DHA-La | 1.25 |
| COF-TPB-DMA-0.5DHA-La | 0.84 |
| COF-TPB-DMA-xDHA-La@nylon-66 | 0.12 |

### Hydrolysis of Nerve-Agent Simulants

The degradation of 2-chloroethyi ethyl sulfide (CEES), was studied employing 10 mg of each activated material suspended in the mixture of EtOH and H₂O (V/V=1/1, 0.5 mL). Afterwards, 2.5 μL of CEES was added to the suspension. The evolution of the concentration of CEES was followed at room temperature by means of ¹H NMR. Results are provided in Table 2.

TABLE 2
Catalytic data of hydrolysis of CEES catalyzed over various catalytic
systems.^{[a]}

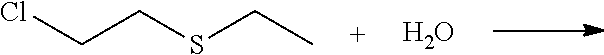

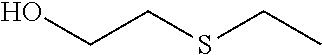

| | t_{1/2} | TOF | Time | Conv. |
|---|---|---|---|---|
| Catalyst | (min) | (min⁻¹) | (min) | (%) |
| COF-TPB-DHA-La | 8 | 0.054 | 25 | 98 |
| COF-TPB-DMA-2DHA-La | 8 | 0.0795 | 25 | 97 |
| COF-TPB-DMA-DHA-La | 10 | 0.84 | 30 | 97 |
| COF-TPB-DMA-0.5DHA-La | 40 | 0.031 | 160 | 89 |
| COF-TPB-DMA-xDHA- | 25 | 0.133 | 60 | 96 |
| La@nylon-66^{[b]} | | | | |
| UiO-66 | — | — | 600 | 32 |
| MOF-808 | — | — | 600 | 48 |
| NaOH (1M) | 7 | | 25 | 98 |
| Blank | — | — | 600 | 13 |

^{[a]}Reaction conditions: CEES (2.5 μL, 0.02 mmol), H₂O:EtOH (1:1, 0.5 mL), catalyst (10 mg), RT;
TOF was calculated based on the time when the conversion reached to around 50%.
^{[b]}25 mg of the composite was used.

The degradation of dimethyl methylphosphonate (DMMP), was studied employing 20 mg of each activated material suspended in 0.5 mL of H₂O. Afterwards, 2.5 μL of DMMP was added to the suspension. The evolution of the concentration of DMMP was followed at room temperature by means of ¹H NMR. Results are provided in Table 3. Table 4 provides results using the organic frameworks described herein for the hydrolysis of Soman (GD) (3,3-dimethylbutan-2-yl methylphosphonofluoridate).

TABLE 3
Catalytic data of hydrolysis of DMMP catalyzed over various catalytic
systems.^{[a]}

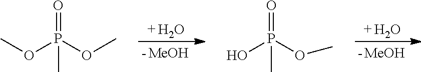

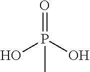

| | | TOF | Time | Conv. |
|---|---|---|---|---|
| Catalyst | t_{1/2} (min) | (min⁻¹) | (min) | (%) |
| COF-TPB-DHA-La | 26 | 0.0091 | 120 | 97 |
| COF-TPB-DMA-2DHA-La | 28 | 0.012 | 120 | 97 |
| COF-TPB-DMA-DHA-La | 35 | 0.0131 | 150 | 95 |
| COF-TPB-DMA-0.5DHA-La | 120 | 0.0057 | 300 | 82 |
| COF-TPB-DMA-xDHA- | 60 | 0.063 | 200 | 95 |
| La@nylon-66^{[b]} | | | | |
| UiO-66 | — | — | 600 | 16 |
| MOF-808 | — | — | 600 | 26 |
| NaOH (1M) | 90 | | 600 | 68 |
| Blank | — | — | 600 | 3 |

^{[a]}Reaction conditions: DMMP (2.5 μL, 0.023 mmol), H₂O (0.5 mL), catalyst (20 mg), RT.
^{[b]}25 mg of the composite was used.

TABLE 4
Catalytic data of hydrolysis of Soman (GD)
catalyzed over various catalytic systems.

| Catalyst | t_{1/2} (min) |
|---|---|
| COF-TPB-DHA-La | 578 |
| COF-TPB-DMA-DHA-La | 82 |
| COF-TPB-DMA-0.5DHA-La | 533 |

Reaction conditions: catalyst (30 mg) dosed with 3 μL GD and 1 mL H₂O/D₂O

From the foregoing, it will be seen that aspects herein are well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings is to be interpreted as illustrative and not in a limiting sense.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

### REFERENCES

1. Asahi, R., Morikawa, T., Ohwaki, T., Aoki, K., and Taga, A. Y. (2001). Visible-light photocatalysis in nitrogen-doped titanium oxides. Science 293, 269-271.
2. Lang, X., Chen, X., and Zhao, J. (2014). Heterogeneous visible light photocatalysis for selective organic transformations. Chem. Soc. Rev. 43, 473-486.
3. Yoon, T. P., Ischay, M. A., and Du, J. (2010). Visible light photocatalysis as a greener approach to photochemical synthesis. Nat. Chem. 2, 527-532.
4. Wang, X., Zhang, L., Chen, Z., Hu, J., Li, S., Wang, Z., Liu, J., and Wang, X. (2014). Semiconductor heterojunction photocatalysts: design, construction, and photocatalytic performances. Chem. Soc. Rev. 43, 5234-5244.
5. Romero, N. A., and Nicewicz, D. A. (2016). Organic photoredox catalysis. Chem. Rev. 116, 10075-10166.
6. McAtee, R. C., McClain, E. J., and Stephenson, C. R. J. (2019). Illuminating photoredox catalysis. Trends in Chemistry 1, 111-125.
7. Romero, N. A., and Nicewicz, D. A. (2016). Organic photoredox catalysis. 116, 10075-10166.
8. Liang, H.-P., Chen, Q., and Han, B.-H. (2018). Cationic polycarbazole networks as visible-light heterogeneous photocatalysts for oxidative organic transformations. ACS Catal. 8, 5313-5322.
9. Zhang, G., Lan, Z.-A., and Wang, X. (2016). Conjugated polymers: catalysts for photocatalytic hydrogen evolution. Angew. Chem. Int. Ed. 55, 15712-15727.
10. Ma, L., Liu, Y., Liu, Y., Jiang, S., Li, P., Hao, Y., Shao, P., Yin, A., Feng, X., and Wang, B. (2019). Ferrocene-linkage-facilitated charge separation in conjugated microporous polymers. Angew. Chem. Int. Ed. 58, 4221-4226.
11. Zhang, K., Kopetzki. D., Seeberger, P. H., Antonietti, M., and Vilela, F. (2013). Surface area control and photacatalytic activity of conjugated microporous poly(benzothiadiazole) networks. Angew. Chem. Int. Ed. 52, 1432-1436.
12. Wu, W., Xu, S., Qi, G., Zhu, H., Hu, F., Liu, Z., Zhang, D., and Liu, B. (2019). A cross-linked conjugated polymer photosensitizer enables efficient sunlight-induced photooxidation. Angew. Chem. Int. Ed. 58, 3062-3066.
13. Li, L., Cai, Z., Wu, W.-Y., Zhang, N., Chen, L. X., and Yu, L. (2016). Rational design of porous conjugated polymers and roles of residual palladium for photocatalytic hydrogen production. J. Am. Chem. Soc. 138, 7681-7686.
14. Sprick, R. S., Jiang, J.-X., Bonillo, B., Ren, S., Ratvijitvech, T., Guiglion, P., Zwijnenburg, M. A., Adams, D. J., and Cooper, A. I. (2015). Tunable organic photocatalysts for visible-light-driven hydrogen evolution. J. Am. Chem. Soc. 137, 3265-3270.
15. Zhang, T., and Lin, W. (2014). Metal-organic frameworks for artificial photosynthesis and photocatalysis. Chem. Soc. Rev. 43, 5982-5993.
16. Li, R., Byun, J., Huang, W., Ayed, C., Wang, L., and Zhang, K. A. I. (2018). Poly(benzothiadiazoles) and their derivatives as heterogeneous photocatalysts for visible-light-driven chemical transformations. ACS Catal. 8, 4735-4750
17. Yu, X., Yang, Z., Qiu, B., Guo, S., Yang, P., Yu, B., Zhang, H., Zhao, Y., Yang, X., Han, B., and Liu, Z. (2019). Eosin Y-functionalized conjugated organic polymers for visible light-driven CO₂ reduction with H₂O to CO with high efficiency. Angew. Chem. Int. Ed. 58, 632-636.
18. Sun, D., Jang, S., Yim, S.-J., Ye, L., and Kim, D.-P. (2018). Metal doped core-shell metal-organic frameworks@covalent organic frameworks (MOFs@COFs) hybrids as a novel photocatalytic platform. Adv. Funct. Mater. 28, 1707110.
19. Xiao, J.-D., and Jiang, H.-L. (2019). Metal-organic frameworks for photocatalysis and photothermal catalysis. Acc. Chem. Res. 52, 356-366.
20. Côté, A. P., Benin, A. I., Ockwig, N. W., O'Keeffe, M., Matzger, A. J., and Yaghi, O. M. (2005). Porous, crystalline, covalent organic frameworks. Science 310, 1166-1170
21. Feng, X., Ding, X., and Jiang, D. (2012). Covalent organic frameworks. Chem. Soc. Rev. 41, 6010-6022
22. Ding, S.-Y., and Wang, W. (2013). Covalent organic frameworks (COFs): from design to applications. Chem. Soc. Rev. 42, 548-568
23. Song, Y., Sun, Q., Aguila, B., and Ma, S. (2019). Opportunities of covalent organic frameworks for advanced applications. Adv. Sci. 8, 1801410.
24. Bisbey, R. P., and Dichtel, W. R. (2017). Covalent organic frameworks as a platform for multidimensional polymerization. ACS. Cent. Sci. 3, 533-543
25. Zhou, T.-Y., Xu, S.-Q., Wen, Q., Pang, Z.-F., and Zhao, X. (2014). One-step construction of two different kinds of pores in a 2D covalent organic framework. J. Am. Chem. Soc. 136, 15885-15888
26. Kandambeth, S., Dey, K., and Banerjee, R. (2019). Covalent organic frameworks: chemistry beyond the structure. J. Am. Chem. Soc. 141, 1907-1822
27. Lohse, M. S., and Bein, T. (2018). Covalent organic frameworks: structures, synthesis, and applications. Adv. Funct. Mater. 28, 170553
28. Jin, Y., Hu, Y., and Zhang, W. (2017). Tessellated multiparous two-dimensional covalent organic frameworks. Nat. Rev. Chem. 1, s41570-017
29. Sun, Q., Aguila, B., Perman, J. A., Nguyen, N., and Ma, S. (2016). Flexibility matters: cooperative active sites in covalent organic framework and threaded ionic polymer. J. Am. Chem. Soc. 138, 15790-15796.
30. Wang, X., Han, X., Zhang, J., Wu, X., Liu, Y., and Cui, Y. (2016). Homochiral 2D porous covalent organic frameworks for heterogeneous asymmetric catalysis J. Am. Chem. Soc. 138, 12332-12335
31. Lu, S., Hu, Y., Wan, S., McCaffrey, R., Jin, Y., Gu, H., and Zhang, W. (2017). Synthesis of ultrafine and highly dispersed metal nanoparticles confined in a thioether-containing covalent organic framework and their catalytic applications. J. Am. Chem. Soc. 139, 17082-17088
32. Liu, H., Chu, J., Yin, Z., Cai, X., Zhuang, L., and Deng, H. (2018). Covalent organic frameworks linked by amine bonding for concerted electrochemical reduction of CO₂. Chem 4, 1696-1709
33. Sun, Q., Aguila, B., Perman, J., Earl, L., Abney, C., Cheng, Y., Wei, H., Nguyen, N., Wojtas, L., and Ma, S. (2017). Postsynthetically modified covalent organic frameworks for efficient and effective mercury removal. J. Am. Chem. Soc. 139, 2786-2793.
34. Huang, N., Zhai, L., Xu, H., and Jiang, D. (2017). Stable covalent organic frameworks for exceptional mercury removal from aqueous solutions. J. Am. Chem. Soc. 139, 2428-2434
35. Li, Z., Li, H., Guan, X., Tang, J., Yusran, Y., Li, Z., Xue, M., Fang, Q., Yan, Y., Valtchev, V., and Qiu, S. (2017). Three-dimensional ionic covalent organic frameworks for rapid, reversible, and selective ion exchange. J. Am. Chem. Soc. 139, 17771-17774
36. Kandambeth, S., Venkatesh, V., Shinde, D. B., Kumari, S., Halder, A., Verma, S., and Banerjee, R. (2015). Self-templated chemically stable hollow spherical covalent organic framework. Nat. Commun. 6, 6786
37. Peng, Y., Huang, Y., Zhu, Y., Chen, B., Wang, L., Lai, Z., Zhang, Z., Zhao, M., Tan, C., Yang, N., Shao, F., Han, Y., and Zhang, H. (2017). Ultrathin two-dimensional covalent organic framework nanosheets: preparation and application in highly sensitive and selective DNA detection. J. Am. Chem. Soc. 139, 8698-8704.
38. Sun, Q., Fu, C.-W., Aguila, B., Perman, J. A., Wang, S., Huang, H.-Y., Xiao, F.-S., and Ma, S. (2018). Pore environment control and enhanced performance of enzymes infiltrated in covalent organic frameworks. J. Am. Chem. Soc. 140, 984-992
39. Ma, H., Liu, B., Li, B., Zhang, L., Li, Y.-G., Tan, H.-Q., Zang, H.-Y., and Zhu, G. (2016). Cationic covalent organic frameworks: a simple platform of anionic exchange for porosity tuning and proton conduction. J. Am. Chem. Soc. 138, 5897-5903
40. Zeng, Y., Zou, R., and Zhao, Y. Covalent organic frameworks for CO₂ capture. (2016). Adv. Mater. 28, 2855-2873
41. Wang, S., Wang, Q., Shao, P., Han, Y., Gao, X., Ma, L., Yuan, S., Ma, X., Zhou, J., Feng, X., and Wang, B. (2017). Exfoliation of covalent organic frameworks into few-layer redox-active nanosheets as cathode materials for lithium-ion batteries. J. Am. Chem. Soc. 139, 4258-4261.
42. Chen, R., Shi, J.-L., Ma, Y., Lin, G., Lang, X., and Wang, C. (2019). Designed synthesis of a 2D porphyrin-based sp² carbon conjugated covalent organic framework for heterogeneous photocatalysis. Angew. Chem. Int. Ed. 58, 6430-6434
43. Lv, J., Tan, Y.-X., Xie, J., Yang, R., Yu, M., Sun, S., Li, M.-D., Yuan, D., and Wang, Y. (2018). Direct solar-to-electrochemical energy storage in a functionalized covalent organic framework. Angew. Chem. Int. Ed. 57, 12716-12720
44. Yang, S., Hu, W., Zhang, X., He, P., Pattengale, B., Liu, C., Cendejas, M., Hermans, I., Zhang, X., Zhang, J., and Huang, J. (2018). 2D covalent organic Frameworks as intrinsic photocatalysts for visible light-driven CO₂ reduction. J. Am. Chem. Soc. 140, 14614-14618.
45. Pachfule, P., Acharjya, A., Roeser, J., Langenhahn, T., Schwarze, M., Schomäcker, R., Thomas, A., and Schmidt, J. (2018). Diacetylene functionalized covalent organic framework (COF) for photocatalytic hydrogen generation. J. Am. Chem. Soc. 140, 1423-1427.
46. Keller, N., Bessinger, D., Reuter, S., Calik, M., Ascheri, L., Hanusch, F. C., Auras, F., and Bein, T. (2017). Oligothiophene-bridged conjugated covalent organic frameworks. J. Am. Chem. Soc. 139, 8194-8199.
47. Vyas, V. S., Haase, F., Stegbauer, L., Savasci, G., Podjaski, F., Ochsenfeld, C., and Lotsch, B. V. (2015). A tunable azine covalent organic framework platform for visible light-induced hydrogen generation. Nat. Commun. 6, 8508
48. Wei, P.-F., Qi, M.-Z., Wang, Z.-P., Ding, S.-Y., Yu, W., Liu, Q., Wang, L.-K., Wang, H.-Z., An, W.-K., and Wang, W. (2018). Benzoxazole-linked ultrastable covalent organic frameworks for photocatalysis. J. Am. Chem. Soc. 140, 4623-4631.
49. Li, Z., Zhi, Y., Shao, P., Xia, H., Li, G., Feng, X., Chen, X., Shi, Z., and Liu, X. (2019). Covalent organic framework as an efficient, metal-free, heterogeneous photocatalyst for organic transformations under visible light. Appl. Catal. B. Envir. 245, 334-342.
50. Zhao, Y., Liu, H., Wu, C., Zhang, Z., Pan, Q., Hu, F., Wang, R., Li, P., Huang, X., and Li, Z. (2019). Fully conjugated two-dimensional sp²-carbon covalent organic frameworks as artificial photosystem I with high efficiency. Angew. Chem. Int. Ed. 58, 5376-5381
51. He, J., Yin, B., Niu, H., and Cai, Y. (2018). Targeted synthesis of visible-light-driven covalent organic framework photocatalyst via molecular design and precise construction. Appl. Catal. B. Envir. 239, 147-153
52. Wu, C., Liu, Y., Liu, H., Duan, C., Pan, Q., Zhu, J., Hu, F., Ma, X., Jiu, T., Li, Z., and Zhao, Y. (2018). Highly conjugated three-dimensional covalent organic frameworks based on spirobifluorene for perovskite solar cell enhancement. J. Am. Chem. Soc. 140, 10016-10024.
53. Bhadra, M., Kandambeth, S., Sahoo, M. K., Addicoat, M., Balaraman, E., and Banerjee, R. (2019). Triazine functionalized porous covalent organic framework for photo-organocatalytic E-Z isomerization of olefins J. Am. Chem. Soc. 141, 6152-6156
54. Jin, E., Lan, Z., Jiang, Q., Geng, K., Li, G., Wang, X., and Jiang, D. (2019). 2D sp² carbon-conjugated covalent organic frameworks for photocatalytic hydrogen production from water. Chem 5, 1632-1647.
55. Li, X., Gao, Q., Aneesh, J., Xu, H.-S., Chen, Z., Tang, W., Liu, C., Shi, X., Adarsh, K. V., Lu, Y., and Loh, K. P. (2018). Molecular engineering of bandgaps in covalent organic frameworks. Chem. Mater. 30, 5743-5749.
56. Wang, X., Chen, L., Chong, S. Y., Little, M. A., Wu, Y., Zhu, W.-H., Clowes, R., Yan, Y., Zwijnenburg, M. A., Sprick, R. S., and Cooper, A. I. (2018). Sulfone-containing covalent organic frameworks for photocatalytic hydrogen evolution from water. Nat. Chem. 10, 1180-1189.
57. Sprick, R. S., Bonillo, B., Clowes, R., Guiglion, P., Brownbill, N. J., Slater, B. J., Blanc, F., Zwijnenburg, M. A., Adams, D. J., and Cooper, A. I. (2016). Visible-light-driven hydrogen evolution using planarized conjugated polymer photocatalysts. Angew. Chem. Int. Ed. 55, 1792-1796.
58. DeRosa, M. C., and Crutchley, R. J. (2002). Photosensitized singlet oxygen and its applications. Coord. Chem. Rev. 233-234, 351-371.
59. Tobin, J. M., McCabe, T. J. D., Prentice, A. W., Holzer, S., Lloyd, G. O., Paterson, M. J., Arrighi, V., Cormack, P. A. G., and Vilela, F. (2017). Polymer-supported photosensitizers for oxidative organic transformations in flow and under visible light irradiation. ACS Catal. 7, 4602-4612.
60. Thomas, S., Li, H., Zhong, C., Matsumoto, M., Dichtel, W. R., and Bredas, J.-L. (2019). Electronic structure of two-dimensional 7-conjugated covalent organic frameworks. Chem. Mater. 31, 3051-3065
61. Wang, Z. J., Ghasimi, S., Landfester, K., and Zhang, K. A. I. (2014). Highly porous conjugated polymers for selective oxidation of organic sulfides under visible light. Chem. Commun. 50, 8177-8180.
62. Battula, V. R., Singh, H., Kumar, S., Bala, I., Pal, S. K., and Kailasam, K. (2018). Natural sunlight driven oxidative homocoupling of amines by a truxene-based conjugated microporous polymer. ACS Catal. 8, 6751-6759.
63. Wang, Z. J., Ghasimi, S., Landfester, K., and Zhang, K. A. I. (2015). Molecular structural design of conjugated microporous poly(benzooxadiazole) networks for enhanced photocatalytic activity with visible light. Adv. Mater. 27, 6265-6270
64. Mondloch, J. E., Katz, M. J., Isley Iii, W. C., Ghosh, P., Liao, P., Bury, W., Wagner, G. W., Hall, M. G., DeCoste, J. B., Peterson, G. W., Snurr, R. Q., Cramer, C. J., Hupp, J. T., and Farha, 0. K. (2015). Destruction of chemical warfare agents using metal-organic frameworks. Nat. Mater. 14, 512-516.

What is claimed is:

1. An organic framework comprising a plurality of structural units comprising a structure of formula I 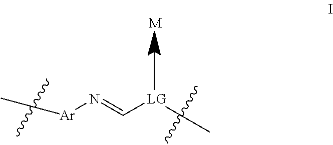
wherein Ar is a fused aromatic group or polyaromatic group; LG is a ligand; and
M is a transition metal, a lanthanide, or an actinide.

2. The organic framework of claim 1, wherein the fused aromatic group comprises 2 to 10 fused aromatic groups.

3. The organic framework of claim 1, wherein the fused aromatic group comprises naphthalene, anthracene, acenaphthene, acenaphthylene, fluorene, phenalene, phenanthrene, benzo[a]anthracene, benzo[a]fluorine, benzo[c]phenanthrene, chrysene, fluoranthene, tetracene, anthanthrene, benzopyrene, pyrene, benzo[a]pyrene, benzo[e]pyrene, benzo[b]fluoranthene, benzo[j]fluoranthene, benzo[k]fluoranthene, corannulene, coronene, dicoronylene, diindenoperylene, helicene, heptacene, hexacene, kekulene, ovalene, pentacene, perylene, picene, or tetraphenylenepentacene.

4. The organic framework of claim 1, wherein the fused aromatic group comprises a pyrene.

5. The organic framework of claim 1, wherein the fused aromatic group is substituted with 2 to 8 aryl groups.

6. The organic framework of claim 1, wherein the fused aromatic group comprises a structure of formula II

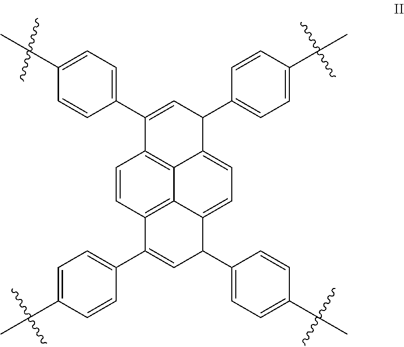 [SMILES: *c1ccc(C2=CC(c3ccc(*)cc3)c3ccc4c5c(ccc2c35)C(c2ccc(*)cc2)=CC4c2ccc(*)cc2)cc1]

7. The organic framework of claim 1, wherein the ligand comprises an aryl group substituted with one or more hydroxyl groups, alkoxy groups, substituted or unsubstituted amino groups, thiol groups, thioalkyl groups, or any combination thereof.

8. The organic framework of claim 1, wherein the ligand comprises an aryl group substituted with two hydroxyl groups.

9. The organic framework of claim 1, wherein the ligand comprises a structure of formula III 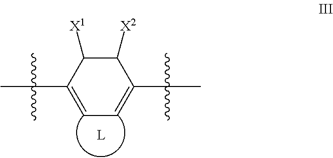
wherein L is not present or L is a fused aromatic group comprising 1 to 10 aromatic groups, and
X¹ and X² are, independently, a hydroxyl group, an amino group, an alkoxy group, or a thiol group.

10. The organic framework of claim 9, wherein L is not present.

11. The organic framework of claim 10, wherein X¹ and X² are hydroxyl groups.

12. The organic framework of claim 1, wherein a structural unit comprises a structure of formula IV 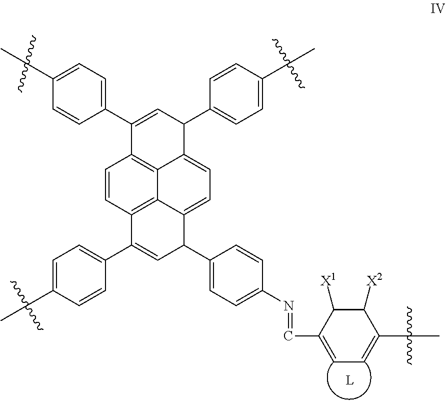
wherein L is not present or L is a fused aromatic group comprising 1 to 10 aromatic groups, and
X¹ and X² are, independently, a hydroxyl group, an amino group, an alkoxy group, or a thiol group.

13. The organic framework of claim 12, wherein L is not present.

14. The organic framework of claim 13, wherein X¹ and X² are hydroxyl groups.

15. The organic framework of claim 1, wherein Ar is a polyaromatic group that comprises a structure of formula V

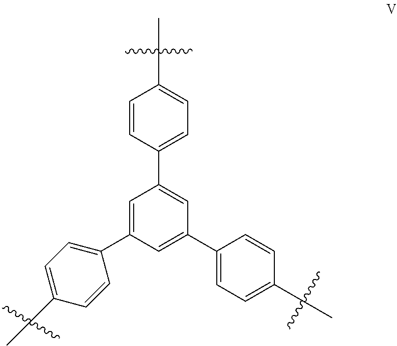 [SMILES: *c1ccc(-c2cc(-c3ccc(*)cc3)cc(-c3ccc(*)cc3)c2)cc1]

16. The organic framework of claim 1, wherein a structural unit comprises a structure of formula VI 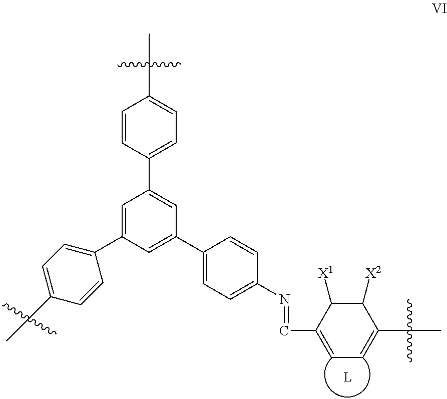
wherein L is not present or L is a fused aromatic group comprising 1 to 10 aromatic groups, and
X¹ and X² are, independently, a hydroxyl group, an amino group, an alkoxy group, or a thiol group.

17. The organic framework of claim 16, wherein L is not present.

18. The organic framework of claim 17, wherein X¹ and X² are hydroxyl groups.

19. The organic framework of claim 1, wherein the framework comprises a plurality of structural units having the structure depicted in FIG. 1 or 2.

20. The organic framework of claim 1, wherein M is a transition metal.

21. The organic framework of claim 1, wherein M is La (III), Al (III), or Zr (IV).

22. An organic framework produced by (1) reacting a fused aromatic group or a polyaromatic group substituted with three or more amino groups with a ligand that comprises two or more aldehyde groups to produce a first organic framework, and (2) reacting the first organic framework with a transition metal to produce the organic framework.

23. The organic framework of claim 22, wherein the fused aromatic group is 1,3,6,8-tetrakis(4-aminophenyl)pyrene.

24. The organic framework of claim 22, wherein the polyaromatic group is 1,3,5-tris-(4-aminophenyl)benzene (TPB).

25. The organic framework of claim 22, wherein the ligand comprises a structure of formula VII 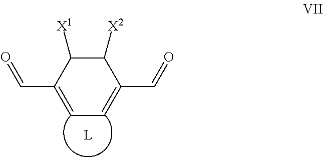
wherein L is not present or L is a fused aromatic group comprising 1 to 10 aromatic groups, and X¹ and X² are, independently, a hydroxyl group, an amino group, or a thiol group.

26. A method for hydrolyzing an organic compound, the method comprising: reacting the organic compound with water in the presence of the organic framework according to claim 1.

27. The method of claim 26, wherein the organic compound is a nerve agent.

28. The method of claim 27, wherein the organic compound is a halo-sulfo compound.

29. The method of claim 26, wherein the organic compound is 2-chloroethyl ethyl sulfide or bis(2-chloroethyl) sulfide, diisopropyl phosphorofluoridate, dimethyl methylphosphonate, diethylsulfane, or 3,3-dimethylbutan-2-yl methylphosphonofluoridate.

30. A fiber comprising a coating of the organic framework according to claim 1.
